(19) United States
(12) Patent Application Publication
(10) Pub. No.: US 2008/0026171 A1
(43) Pub. Date: Jan. 31, 2008

(54) Coextruded film with polylactic acid (PLA) and Ethylene Vinyl Acetate (EVA)

(75) Inventors: George Gullick, Neenah, WI (US); Stacey Ross Isonhood, Appleton, WI (US); Edward R. Sanders, Fremont, WI (US)

Correspondence Address: BANNER & WITCOFF, LTD., TEN SOUTH WACKER DRIVE, SUITE 3000, CHICAGO, IL, 60606, US

(73) Assignee: Alcan Packaging Flexible France, Paris (FR)

(21) Appl. No.: 11/829,610

(22) Filed: Jul. 27, 2007

Related U.S. Application Data
(60) Provisional application No. 60/820,737, filed on Jul. 28, 2006.

(51) Int. Cl. B32B 27/08; B29D 22/00; B32B 7/00

(52) U.S. Cl. 428/35.4; 264/171.28; 428/213; 428/218; 428/518

(57) ABSTRACT

A multilayer film comprising, in order, a polyolefin or extrudable layer, a first layer comprising ethylene vinyl acetate (EVA), and a layer comprising polylactic acid (PLA). In a preferred embodiment, the multilayer film comprises, in order, a polyolefin layer, a first layer comprising ethylene vinyl acetate (EVA), a core layer comprising polylactic acid (PLA), a second layer comprising EVA, and a sealant layer. A method and system for forming the multilayer film is also disclosed.

### FIELD OF THE INVENTION

The invention relates to a coextruded film comprising a multilayer structure comprising polylactic acid.

More particularly, the invention relates to coextruded films comprising polylactic acid and ethylene vinyl acetate, and the use of such films for packaging of products, such as food products.

### BACKGROUND OF THE INVENTION

Polylactic acid (PLA) exhibits good flavor and aroma barrier characteristics. See e.g., Whiteman, Nicole; DeLassus, Phillip; Gunderson, Judy, “New flavor and aroma barrier thermoplastic, polylactide,” Polym., Laminations, & Coat. Conf. (Polymers, Laminations, & Coatings Conference, San Diego, Calif., United States, Aug. 26-30, 2001). However, because PLA is a very polar molecule it has poor adhesion to many common polyolefins, and attempts to make flavor and aroma films containing PLA have heretofore not been suitable for flexible packaging applications, such as bags to contain consumer food products like cereals.

### BRIEF SUMMARY OF THE INVENTION

The present invention provides a multilayer film comprising a suitable polyolefin or extrudable resin layer, a first layer comprising ethylene vinyl acetate (EVA), and a layer comprising polylactic acid (PLA), wherein the first layer comprising EVA is located between the polyolefin or extrudable resin layer and the layer comprising PLA. In a preferred embodiment, a second layer comprising EVA is provided, wherein the layer comprising PLA is located between the first and second layers comprising EVA. In a further preferred embodiment, a sealant layer is provided, wherein the second layer comprising EVA is located between the layer comprising PLA and the sealant layer.

The layers comprising the multilayer film of the present invention can be coextruded in a multilayer extrusion process system. The multilayer film can be rolled and later used to make flexible packaging for consumer goods, e.g., dry food, meat, or cheese.

Also described herein are methods for producing the multilayer films.

### BRIEF DESCRIPTION OF THE DRAWINGS

Non-limiting preferred embodiments of the multilayer films in accordance with the present invention will now be described with reference to the accompanying drawings.

FIG. 1 shows a multilayer blown film process system for use in accordance with an embodiment of the present invention.

FIG. 2 illustrates a multilayer film in accordance with an embodiment of the present invention.

FIG. 3 illustrates a multilayer film in accordance with an embodiment of the present invention.

### DETAILED DESCRIPTION OF EMBODIMENTS

The layers comprising the multilayer film can be coextruded in a multilayer extrusion process, such as a blown film process. Other extrusion processes can be used, such as cast and tubular water quench extrusion processes.

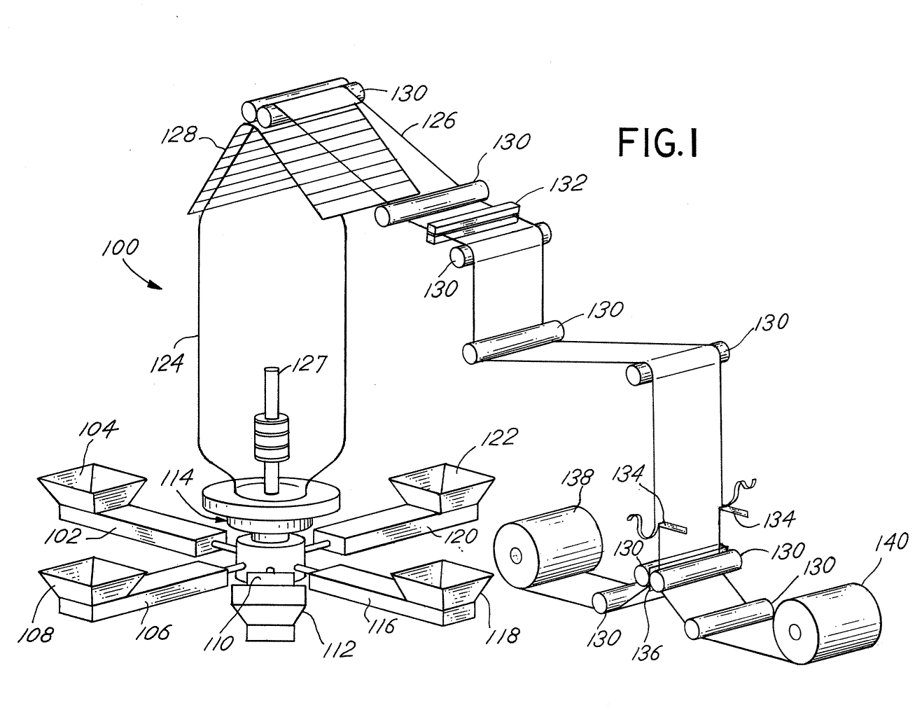

FIG. 1 shows a multilayer blown film process system 100 in accordance with embodiments of the present invention. Extruder 102 extrudes a layer comprising a suitable polyolefin or extrudable resin (e.g., high density polyethylene, linear low density polyethylene (LLDPE), nylon, ethylene vinyl alcohol (EVOH)) from source 104. Extruder 106 extrudes a composition comprising EVA from an EVA source 108. Extruder 110 extrudes a composition comprising PLA from a PLA source 112. Die 114 receives the extruded compositions from extruders 102, 106 and 110. The term “high density” herein means a density of about 0.95 to 0.96 g/cc and having chains which are virtually linear (i.e., no side chain branching). The term “linear low density” herein means a density of about 0.905 to 0.925 g/cc and is largely linear but with some controlled side chain branching.

In one aspect of the present invention, at die 114, the extruded layer composition from EVA source 106 is located between the extruded layer composition from the suitable polyolefin or extruded resin source 104 and the extruded layer composition from PLA source 112.

Additional extruders can be incorporated to extrude additional compositions for receipt by die 114 to form additional layers. For example, as shown in FIG. 1, extruder 116 extrudes a composition of EVA from an EVA source 118, and extruder 120 extrudes a composition from a sealant source 122. In another aspect of the invention, at die 114, the layer composition from EVA source 118 is located between the layer composition from the PLA source 111 and the layer composition from the sealant source 122.

Each extruder can be used for formation of one layer or multiple layers in a multilayer film.

Die 114 can be an annular die to produce a thin gauge film. Film is sent upwardly from die 114 and gas, such as air, enclosed between annular walls of the film forms a film bubble 124. The bubble 124 is retained in a tower (not shown) and is cooled with chilled air emanating from tube 127 and collapses within collapsing frame 128 to form two adjacent sets of five layer film 126. Film 126 exits collapsing frame 128 and is transported by rollers 130. Film 126 can be further treated, if desired, at treater 132. For example, treater 132 can treat film 126 to increase the surface energy via an electrode.

Film 126 can be trimmed by trimmers 134 and slit by slitter 136 to separate the two adjacent sets of five layer film, and the separated sets of film can be rolled into rolls 138 and 140.

In accordance with embodiments of the invention, provided is a method for making a multilayer film comprising the steps of: coextruding into an annular die a polyolefin layer, a first layer comprising ethylene vinyl acetate (EVA), a layer comprising polylactic acid (PLA), a second layer comprising EVA, and a sealant layer,

forming a bubble comprising the coextruded layers and air,

collapsing bubble,

forming two adjacent sets of multilayer film from the collapsed bubble,

separating the two adjacent sets of multilayer film, and

rolling each separated set of multilayer film into a roll.

In accordance with embodiments of the invention, provided is a system for making a multilayer film comprising:

a source for a polyolefin layer, a source for a first layer comprising ethylene vinyl acetate (EVA), a source for a layer comprising polylactic acid (PLA), a source for a second layer comprising EVA, and source for a sealant layer,

an extruder corresponding to each source,

an annular die adapted to form a bubble,

a source of cooled air to cool the bubble,

a collapsing frame wherein the bubble collapses to form two adjacent sets of multilayer film, and

a slitter adapted to separate the two adjacent sets of multilayer film emanating from the collapsing frame.

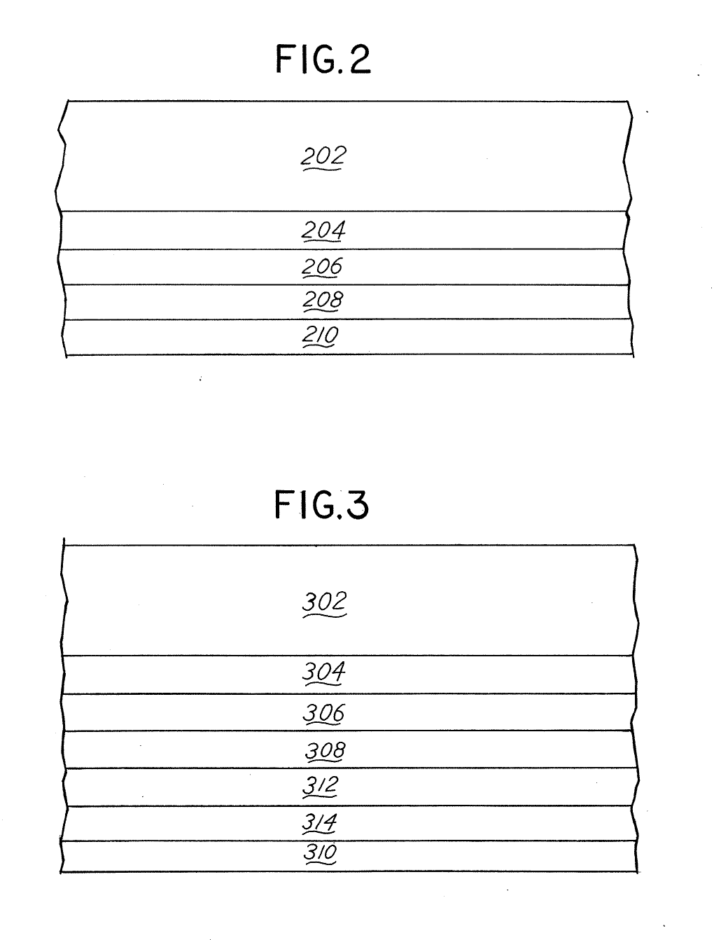

FIG. 2 shows an embodiment of a multilayer film 200 comprising, in order, a polyolefin or extrudable resin layer 202, a first layer 204 comprising EVA, a layer 206 comprising PLA, a second layer 208 comprising EVA, and a sealant layer 210.

The layers comprising the multilayer film shown in FIG. 2 can be coextruded in a multilayer blown film process system, such as the system 100 shown in FIG. 1. Thus, multilayer film 200 can be the films rolled into rolls 138 and 140 shown in FIG. 1.

The multilayer film can be used to make packaging bags for consumer goods, e.g., consumer cereal.

As shown in FIG. 2, layer 204 comprising EVA is in contact with layer 206 comprising PLA on one side of layer 204, and layer 204 comprising EVA is in contact with polyolefin or extrudable resin layer 202 on another side of layer 204. By having this structure, a layer comprising PLA can be used in a multilayer film that also comprises a polyolefin or extrudable resin layer 202, thus solving the problem of PLA having poor adhesion to a polyolefin or extrudable resin.

As shown in FIG. 2, second layer 208 comprising EVA is in contact with layer 206 comprising PLA on one side of layer 208, and layer 208 comprising EVA is in contact with sealant layer 210 on another side of layer 208. By having this structure, a layer comprising PLA can be used in a multilayer film that also comprises a sealant layer 210, thus solving the problem of PLA having poor adhesion to a sealant. A sealant can comprise a polyolefin or extrudable resin.

The use of a layer comprising EVA in contact with a layer comprising PLA allows a layer or layers of PLA to be used in a wide variety of multilayer films in a wide variety of applications, and overcomes the problem of PLA having poor adhesion to other materials and/or layers that do not comprise EVA.

The thickness of the layers can be any suitable thickness to achieve desired properties. Thus, the particular application dictates thickness. For example, the PLA layer might need to be thicker for some applications if more barrier is needed. The tie or EVA layer(s) might need to be thicker or thinner to get the desired mechanical and physical properties for the application. The percent of EVA or PLA in any particular layer can be adjusted to achieve desired properties.

As an example for flexible packaging for cereal, layer 206 has a thickness of about 0.1 to 0.3 mil. In certain embodiments, core layer 206 is substantially pure PLA. However, layer 206 need not be substantially pure PLA. Layer 206 has a thickness and an amount of PLA sufficient to provide a desired flavor and aroma barrier.

As an example for flexible packaging for cereal, first layer comprising EVA, i.e., layer 204, has a thickness of about 0.1 to 0.3 mil., and more preferably about 0.2 mil. In certain embodiments, layer 204 comprises an effective amount of EVA to adhere or tie to PLA in layer 206. Layer 204 can comprise EVA copolymer with various concentrations of ethylene vinyl acetate to copolymer (e.g., 35 to 85% by weight EVA to copolymer).

As an example for flexible packaging for cereal, second layer comprising EVA, i.e., layers 208 has a thickness of about 0.1 to 0.3 mil., and more preferably about 0.2 mil. In certain embodiments, layer 208 comprises an effective amount of EVA to adhere or tie to PLA in layer 206. Layer 208 can comprise EVA copolymer with various concentrations of ethylene vinyl acetate to copolymer (e.g., 35 to 85% by weight EVA to copolymer).

As an example for flexible packaging for cereal, sealant layer 210 has a thickness of about 0.2 to 0.5 mil., or about 0.3 mil. In certain embodiments, layers 210 can comprise a sealant, e.g., Surlyn® made by DuPont, EVA-polybutylene (EVA-PB), or any other suitable sealant. The sealant can be an ionomer type sealant.

When multilayer film 200 is to be used as a bag for cereal, polyolefin composition layer 202 in certain embodiments has a thickness of about 1.0 to 2.0 mil. In certain embodiments, polyolefin or extrudable resin composition layer 202 comprises high density polyethylene. High density compositions herein have a density in the range of 0.95 to 0.96 g/cc.

A bag structure comprising the multilayer film 200, wherein the sealant layer 210 is the innermost layer of the structure, and the polyolefin or extrudable resin layer 202 is the outermost layer of the structure is provided. Any of the layers 202, 204, 206, 208, 210 can comprise a material(s) that provides any desired property or properties, including but not limited to a material(s) that provides any or all of the following properties: air or oxygen barrier, moisture barrier and/or moisture entrapment, puncture resistance, coloring (e.g., via pigment(s) in the layer), UV barrier, and/or antioxidant(s). Sealant layer 210 can comprise more than one sealant material therein, and/or comprise more than sealant layer, each sealant layer comprising one or more sealant materials therein. With the present disclosure of an EVA layer in combination with a PLA layer, those skilled in the art will recognize the wide variety of applications and benefits now made possible.

While five layers are shown in FIG. 2, those skilled in the art will recognize that a different number of can be used. For example, additional layer(s) can be present between layers 202 and 204, and that such additional layer(s) can comprise a material that is the same as or different from the material in layer 202 and/or 204. As another example, additional layer(s) can be present between layers 208 and 210, and that such additional layer(s) can comprise a material that is the same as or different from the material in layer 208 and/or layer 210. Those skilled in the art will recognize that a wide variety of layers can be used in accordance with this disclosure due to a layer comprising EVA being in contact with a layer comprising PLA. As another example, one or more layers comprising PLA can be used in series with each other, such as more than one layer comprising PLA comprising layer 206.

By way of further example, but not limitation, additional layer(s) of various compositions can be added to the multilayer film 200 to achieve any desired property or properties, including but not limited to a layer(s) that provides any or all of the following properties: air or oxygen barrier, moisture barrier and/or moisture entrapment, puncture resistance, coloring (e.g., via pigment(s) in the layer), UV barrier, and/or antioxidant(s). For example, multilayer film 300, shown in FIG. 3, comprises, in order, a polyolefin or extrudable resin layer 302, a first layer 304 comprising EVA, a first layer 306 comprising PLA, a second layer 308 comprising EVA, a second layer 312 comprising PLA, a third layer 314 comprising PLA, and a sealant layer 310. Any of the layers 302, 304, 306, 308, 312, 314 and 310 can comprise a material(s) that provides any desired property or properties, including but not limited to a material(s) that provides any or all of the following properties: air or oxygen barrier, moisture barrier and/or moisture entrapment, puncture resistance, coloring (e.g., via pigment(s) in the layer), UV barrier, and/or antioxidant(s). Sealant layer 310 can comprise more than one sealant material therein, and/or comprise more than sealant layer, each sealant layer comprising one or more sealant materials therein.

While seven layers are shown in FIG. 3, those skilled in the art will recognize that six layers or less can be used, and that additional layers can be added to the seven layers shown in FIG. 3. For example, additional layer(s) can be present between layers 302 and 304, and such additional layer(s) can comprise a material that is the same as or different from the material in layer 302 and/or 304. As another example, additional layer(s) can be present between layers 314 and 310, and such additional layer(s) can comprise a material that is the same as or different from the material in layer 314 and/or layer 310. Those skilled in the art will recognize that a wide variety of layers can be used in accordance with this disclosure due to a layer comprising EVA being in contact with a layer comprising PLA. As another example, one or more layers comprising PLA can be used in series with each other, such as more than one layer comprising PLA comprising layer 306 and/or layer 312.

Those skilled in the art will recognize that the thickness of the multilayer film 200 and/or multilayer film 300, and the thickness of the individual layers therein, can be any suitable thickness obtainable using available equipment and to achieve desired properties, including but not limited to a thickness of the multilayer film being between about 1.0 mil to about 10 mil.

By way of example, but not limitation, a multilayer film 200 or multilayer film 300 having a layer(s) comprising PLA that makes up about 7-13% of the total thickness of the multilayer film can be useful for dry cereal packaging.

Below is a listing of further examples in accordance with embodiments of the present invention.

### EXAMPLES

Multilayer film 200 can be made wherein the layers 202, 204 and 206 collectively have a thickness of about 2.5 mil, and have the following ratios of thickness with respect to each other: 202/204/206:85/5/10.

Multilayer film 200 can be made wherein the layers 202, 204 and 206 collectively have a thickness of about 2.5 mil, and have the following ratios of thickness with respect to each other: 202/204/206:85/7.5/7.5.

Multilayer film 200 can be made wherein the layers 202, 204 and 206 collectively have a thickness of about 2.5 mil, and have the following ratios of thickness with respect to each other: 202/204/206:85/10/5.

Multilayer film 200 can be made wherein the layers 202, 204, 206, 208 and 210 collectively have a thickness of about 2.2 mil, and have the following ratios of thickness with respect to each other: 202/204/206/208/210:64/5/8/5/18.

Multilayer film 200 can be made wherein the layers 202, 204, 206, 208 and 210 collectively have a thickness of about 2.2 mil, and have the following ratios of thickness with respect to each other: 202/204/206/208/210:65/5/7/7/16.

Multilayer film 300 can be made wherein the layers 302, 304 and 306 collectively have a thickness of about 2.5 mil, and have the following ratios of thickness with respect to each other: 302/304/306:85/5/10.

Multilayer film 300 can be made wherein the layers 302, 304 and 306 collectively have a thickness of about 2.5 mil, and have the following ratios of thickness with respect to each other: 302/304/306:85/7.5/7.5.

Multilayer film 300 can be made wherein the layers 302, 304 and 306 collectively have a thickness of about 2.5 mil, and have the following ratios of thickness with respect to each other: 302/304/306:85/10/5.

Multilayer film 300 can be made wherein the layers 302, 304, 306, 308 and 310 collectively have a thickness of about 2.2 mil, and have the following ratios of thickness with respect to each other: 302/304/306/308/310:64/5/8/5/18.

Multilayer film 300 can be made wherein the layers 302, 304, 306, 308 and 310 collectively have a thickness of about 2.2 mil, and have the following ratios of thickness with respect to each other: 302/304/306/308/310:65/5/7/7/16.

Multilayer film 300 can be made wherein the layers 302, 304, 306, 308, 312, 314 and 310 collectively have a thickness of about 2.2 mil, and have the following ratios of thickness with respect to each other: 302/304/306/308/312/314/310:60/5/7/7/5/6/10.

Multilayer film 300 can be made wherein the layers 302, 304, 306, 308, 312, 314 and 310 collectively have a thickness of about 2.2 mil, and have the following ratios of thickness with respect to each other: 302/304/306/308/312/314/310:60/5/7/7/5/10/6.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

1. A multilayer film comprising, in order, a polyolefin or extrudable resin layer, a first layer comprising ethylene vinyl acetate (EVA), and a layer comprising polylactic acid (PLA).

2. The multilayer film of claim 1, wherein the layer comprising PLA is substantially pure PLA.

3. The multilayer film of claim 1, wherein the layer comprising PLA has a thickness of about 0.1 to 0.3 mil.

4. The multilayer film of claim 1, wherein the first layer comprising EVA comprises EVA copolymer wherein the weight percent of EVA to copolymer is in the range of 35 to 85.

5. The multilayer film of claim 1, wherein the first layer comprising EVA has a thickness of about 0.1 to 0.3 mil.

6. The multilayer film of claim 5, wherein the first layer comprising EVA has a thickness of about 0.2 mil.

7. The multilayer film of claim 1 wherein at least one layer comprises a material having at least one property selected from the group consisting of an air barrier, an oxygen barrier, a moisture barrier, moisture entrapment, puncture resistance, coloring, UV barrier, or antioxidant, and any combination thereof.

8. The multilayer film of claim 1, further comprising a second layer comprising EVA, wherein the layer of PLA is located between the first layer comprising EVA and the second layer comprising EVA.

9. The multilayer film of claim 8 wherein at least one layer comprises a material having at least one property selected from the group consisting of an air barrier, an oxygen barrier, a moisture barrier, moisture entrapment, puncture resistance, coloring, UV barrier, or antioxidant, and any combination thereof.

10. The multilayer film of claim 8, further comprising a sealant layer, wherein the second layer comprising EVA is located between the layer comprising PLA and the sealant layer.

11. The multilayer film of claim 10 wherein at least one layer comprises a material having at least one property selected from the group consisting of an air barrier, an oxygen barrier, a moisture barrier, moisture entrapment, puncture resistance, coloring, UV barrier, or antioxidant, and any combination thereof.

12. The multilayer film of claim 10, wherein the sealant layer comprises an ionomer sealant.

13. The multilayer film of claim 10, wherein the sealant layer has a thickness of about 0.2 to 0.5 mil.

14. The multilayer film of claim 13, wherein the sealant layer has a thickness of about 0.3 mil.

15. The multilayer film of claim 13, wherein the second layer comprising EVA comprises EVA copolymer wherein the weight percent of EVA to copolymer is in the range of 35 to 85.

16. The multilayer film of claim 13, wherein the second layer comprising EVA has a thickness of about 0.1 to 0.3 mil.

17. The multilayer film of claim 16, wherein the second layer comprising EVA has a thickness of about 0.2 mil.

18. The multilayer film of claim 1, wherein the polyolefin or extrudable resin layer comprises composition selected from the group consisting of high density polyethylene, linear low density polyethylene (LLDPE), nylon, and ethylene vinyl alcohol (EVOH)).

19. The multilayer film of claim 1, wherein the polyolefin or extrudable resin layer has a thickness of about 1.0 to 2.0 mil.

20. A packaging structure comprising the multilayer film of claim 10, wherein the sealant layer is the innermost layer of the structure, and the polyolefin or extrudable layer is the outermost layer of the structure.

21. The multilayer film of claim 10, further comprising a second layer of PLA, wherein the second layer of EVA is located between the first layer comprising PLA and the second layer comprising PLA.

22. The multilayer film of claim 21 wherein at least one layer comprises a material having at least one property selected from the group consisting of an air barrier, an oxygen barrier, a moisture barrier, moisture entrapment, puncture resistance, coloring, UV barrier, or antioxidant, and any combination thereof.

23. The multilayer film of claim 21, further comprising a third layer comprising EVA, wherein the second layer of PLA is located between the second layer of EVA and the third layer of EVA.

24. The multilayer film of claim 23 wherein at least one layer comprises a material having at least one property selected from the group consisting of an air barrier, an oxygen barrier, a moisture barrier, moisture entrapment, puncture resistance, coloring, UV barrier, or antioxidant, and any combination thereof.

25. The multilayer film of claim 19, further comprising a sealant layer, wherein the third layer comprising EVA is located between the second layer of PLA and the sealant layer.

26. The multilayer film of claim 25 wherein at least one layer comprises a material having at least one property selected from the group consisting of an air barrier, an oxygen barrier, a moisture barrier, moisture entrapment, puncture resistance, coloring, UV barrier, or antioxidant, and any combination thereof.

27. A packaging structure comprising the multilayer film of claim 25, wherein the sealant layer is the innermost layer of the structure, and the polyolefin or extrudable layer is the outermost layer of the structure.

28. A method for making a multilayer film comprising the steps of:
coextruding into an annular die a polyolefin or extrudable layer, a first layer comprising ethylene vinyl acetate (EVA), a layer comprising polylactic acid (PLA), a second layer comprising EVA, and a sealant layer,
forming a bubble comprising the coextruded layers and air,
collapsing the bubble to form two adjacent sets of multilayer film from the collapsed bubble, and
separating the two adjacent sets of multilayer film.

29. The method of claim 28, further comprising the step of rolling each separated set of multilayer film into a roll.

30. A system for making a multilayer film comprising:
a source for polyolefin or extrudable layer, a source for a first layer comprising ethylene vinyl acetate (EVA), a source for a layer comprising polylactic acid (PLA), a source for a second layer comprising EVA, and a source for a sealant layer,
an extruder corresponding to each source,
an annular die adapted to form a bubble,
a source of cooled air to cool the bubble,
a collapsing frame wherein the bubble collapses, and
a slitter adapted to separate two adjacent sets of multilayer film emanating from the collapsing frame.
